(19) United States
(12) Patent Application Publication
(10) Pub. No.: US 2014/0020574 A1
(43) Pub. Date: Jan. 23, 2014

(54) CAN COMPACTING APPARATUS

(71) Applicant: Doyle Carver, Houston, TX (US)

(72) Inventor: Doyle Carver, Houston, TX (US)

(21) Appl. No.: 13/947,010

(22) Filed: Jul. 19, 2013

Related U.S. Application Data
(60) Provisional application No. 61/673,724, filed on Jul. 19, 2012.

(51) Int. Cl. B30B 9/32; B30B 1/04

(52) U.S. Cl. CPC B30B 9/321; B30B 1/04
USPC 100/245; 100/293

(57) ABSTRACT

A can compacting apparatus is provided to compact commercial cans including larger commercial cans. The apparatus comprises an assembly including a top plate member, a concave-shaped base member and a bottom plate member collectively forming a compacting chamber adapted to receive a vertically disposed larger can. The apparatus further comprises a mounting member configured to mount the apparatus against a standing structure, a compactor member configured to supply a compacting surface and guidingly move the surface, a lever member having a pivotally anchored lever and configured to generate force through displacement of the distal end of the lever, and a lever-to-compactor member configured to link the surface and the lever, such that pivotal displacement of the distal end in a downward direction causes the surface to guidingly urge downward against the disposed can, and the downward urging generates big enough counterforce against the can to cause compaction thereof.

### CROSS-REFERENCE TO RELATED APPLICATION

This application claims the benefit under 35 U.S.C. §119(e) of Provisional Patent Application No. 61/673,724, filed Jul. 19, 2012, the entire disclosure of which is hereby incorporated by reference.

### BACKGROUND

1. Technical Field

The present disclosure generally relates to a can compacting apparatus. More particularly, the present disclosure relates to a can compacting apparatus that is relatively light weight, easy to mount and operate, and capable of compacting a commercial 25-oz aluminum can with ease.

2. Description of the Related Art

Aluminum can compacting devices have been in existence ever since recycling aluminum cans became a necessary routine in our society conscious of protecting the environment and saving precious natural resources. To Applicant's knowledge, most of the aluminum can compacting devices currently on the market that are light weight and easy to mount, have the capability to compact a commercial 12-oz can. However, only a few of these devices have the capability to compact a commercial 16-oz can, and none of these devices are capable of compacting aluminum cans as large as a commercial 25-oz can (such as a Foster beer can), despite the fact that commercial 25-oz cans have been around for a long time and become more or more prevalent in the beverage and beer drinks market. This is primarily due to the fact that these light-weight devices typically do not provide a compacting space having an outside diameter big enough to hold a 25-oz aluminum can (which, for example, can be as wide as 3⅜″, compared to the 2⅝″ outside diameter for a 12-oz or 16-oz can), and/or are not capable of generating, with their respective light-weight structures, a compacting force or pressure large enough to effectively compact a relatively larger can, such as a commercial 25-oz can.

Thus, there is a need for a need for a can compact device that is lightweight, easy to mount and operate, and capable of compacting a commercial 25-oz aluminum can.

### BRIEF SUMMARY

The present disclosure provides an easy-to-operate and easy-to-mount lightweight can compacting apparatus which has the capability to generate a big enough force to fully compact a relatively larger commercial can, such as a commercial 25-oz can.

The apparatus comprises an assembly including a top plate member, a concave-shaped base member and a bottom plate member collectively forming a compacting chamber adapted to receive a vertically disposed larger can for can-compacting purpose. The apparatus further comprises a compactor member configured to supply a compacting (pressure-exerting) surface and guidingly move the compacting surface. The apparatus further comprises a lever member having a pivotally anchored lever and configured to generate a force through a displacement of the distal end of the lever. The apparatus further comprises a lever-to-compactor member configured to link the compacting surface and the lever, such that pivotal displacement of the distal end of the lever in a downward direction causes the surface to guidingly urge downward against the vertically disposed can, and the downward urging generates a big enough force or counterforce against the can to cause full compaction thereof. The apparatus further comprises a mounting member configured to mount the apparatus against a standing structure so as to realize full compaction of the vertically disposed can.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements may be exaggerated relative to other elements. Embodiments incorporating teachings of the present disclosure are shown and described with respect to the figures presented herein, in which:

FIG. 1 is a perspective view illustrating a first embodiment of a can compacting apparatus of the present disclosure.

FIG. 2 is an exploded view illustrating exemplary components of the first embodiment of a can compacting apparatus of the present disclosure.

FIG. 3 is an enlarged sectional view illustrating exemplary components situated at a top portion of the first embodiment of a can compacting apparatus of the present disclosure.

FIGS. 4A-B are enlarged sectional views illustrating an exemplary compactor member of the first embodiment of a can compacting apparatus of the present disclosure.

FIG. 5 is an en sectional view illustrating exemplary components situated at a bottom portion of the first embodiment of a can compacting apparatus of the present disclosure.

FIG. 6 is pictorial illustrating a sequence of operations performed to compact a commercial 25-oz can using the first embodiment of a can compacting apparatus of the present disclosure.

FIG. 7 is a perspective view illustrating a second embodiment of a can compacting apparatus of the present disclosure.

FIG. 8 is an exploded view illustrating exemplary components of the second embodiment of a can compacting apparatus of the present disclosure.

FIG. 9 is an enlarged sectional view illustrating exemplary components situated at a top portion of the second embodiment of a can compacting apparatus of the present disclosure.

FIGS. 10A-B are enlarged sectional view illustrating an exemplary compactor member of the second embodiment of a can compacting apparatus of the present disclosure.

FIG. 11 is an enlarged sectional view illustrating exemplary components situated at a bottom portion of the second embodiment of a can compacting apparatus of the present disclosure.

### DETAILED DESCRIPTION

In the following detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. The following detailed description is, therefore, not to be taken in a limiting sense, and the scope of the present disclosure is defined by the appended claims and equivalents thereof.

References within the specification to “one embodiment,” “an embodiment,” “embodiments”, and “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

The terminology used herein is for the purpose of describing particular embodiments only and is not intended to be limiting of the disclosure. As used herein, the singular forms “a”, “an” and “the” are intended to include the plural forms as well, “or” includes “and/or,” and reference to a numerical value includes at least that value, unless the context clearly indicates otherwise. Moreover, the use of the terms first, second, etc. do not denote any order or importance, but rather the terms first, second, etc. are used to distinguish one element from another.

Within the descriptions of the different views of the figures, the use of the same reference numerals and/or symbols in different drawings indicates identical, similar, or close related items, and similar or closely related elements can be provided similar names, reference numerals, and reference alpha-numerals throughout the figures. If a reference numeral is once used to refer to a plurality of like elements, unless required otherwise by context, the reference numeral may refer to any, a subset of, or all of, the like elements in the figures bearing that reference numeral. Thus, for example, if reference numeral “114” is once referred to a fastening means or device or any element of the fastening means or device, reference numeral “114” may then also refer to any, a subset of, or all of, the elements of the fastening means or device, or the fastening means or device in its entirety, and reference alpha-numeral “114A” may then refer to one implementation or one portion of the fastening means or device, or any, a subset of, or all of the elements of that implementation or that portion. The specific identifiers/names, reference numerals and reference alpha-numerals assigned to the elements are provided solely to aid in the description and are not meant to imply any limitations (structural or functional or otherwise) on the described embodiments.

In the description, relative terms such as “left,” “right,” “vertical,” “horizontal,” “upper,” “lower,” “top” and “bottom” as well as any derivatives thereof (e.g., “top portion,” “bottom plate,” etc.) should be construed to refer to the logical orientation as then described or as shown in the drawing figure under discussion. These relative terms are for convenience of description and are not intended to convey any limitation with regard to a particular orientation.

Referring now to the detailed descriptions of the disclosed can-compacting apparatus, the disclosed can-compacting apparatus, according to the present disclosure, may comprise a first plate member, a base member, a second plate member, a compactor member, a lever member, a lever-anchoring member, a lever-to-compactor linkage member, a compactor-guiding member, and a mounting member. Each of these constituent members will be described with reference to two exemplary embodiments and respective figures illustrating same.

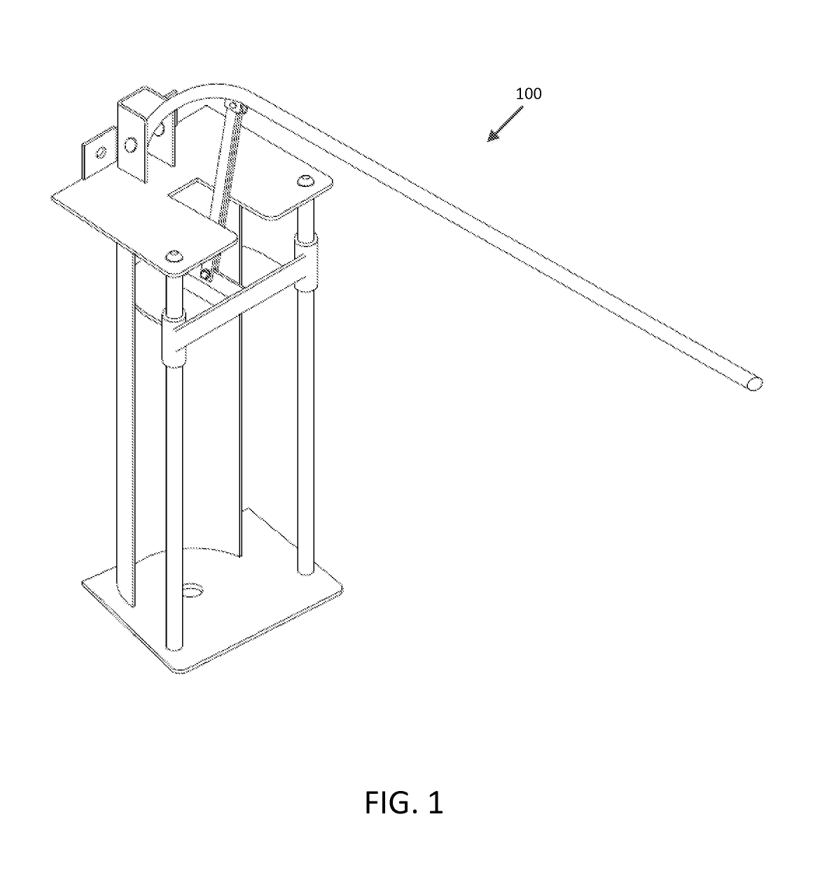

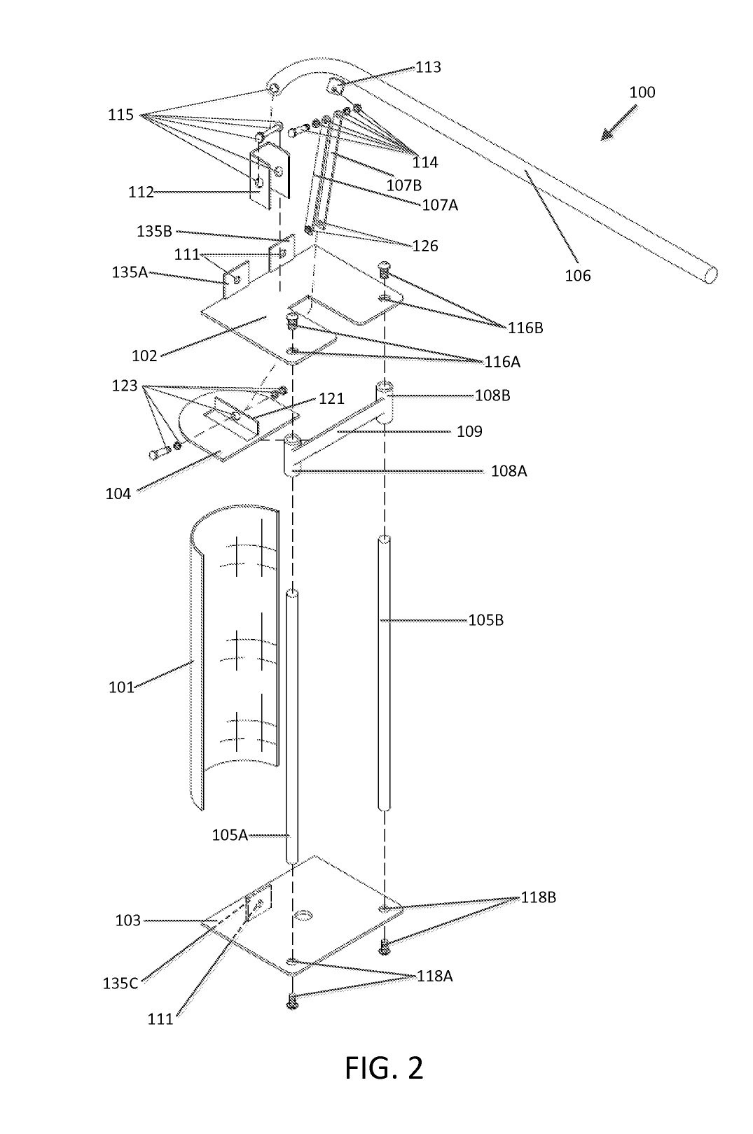

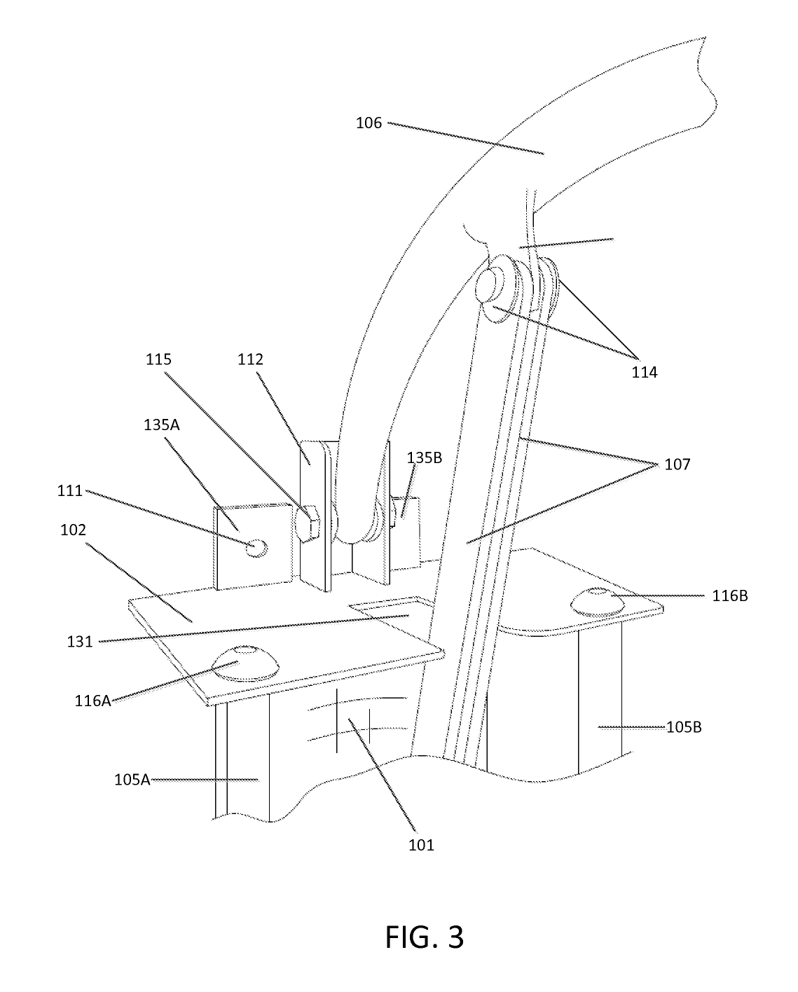

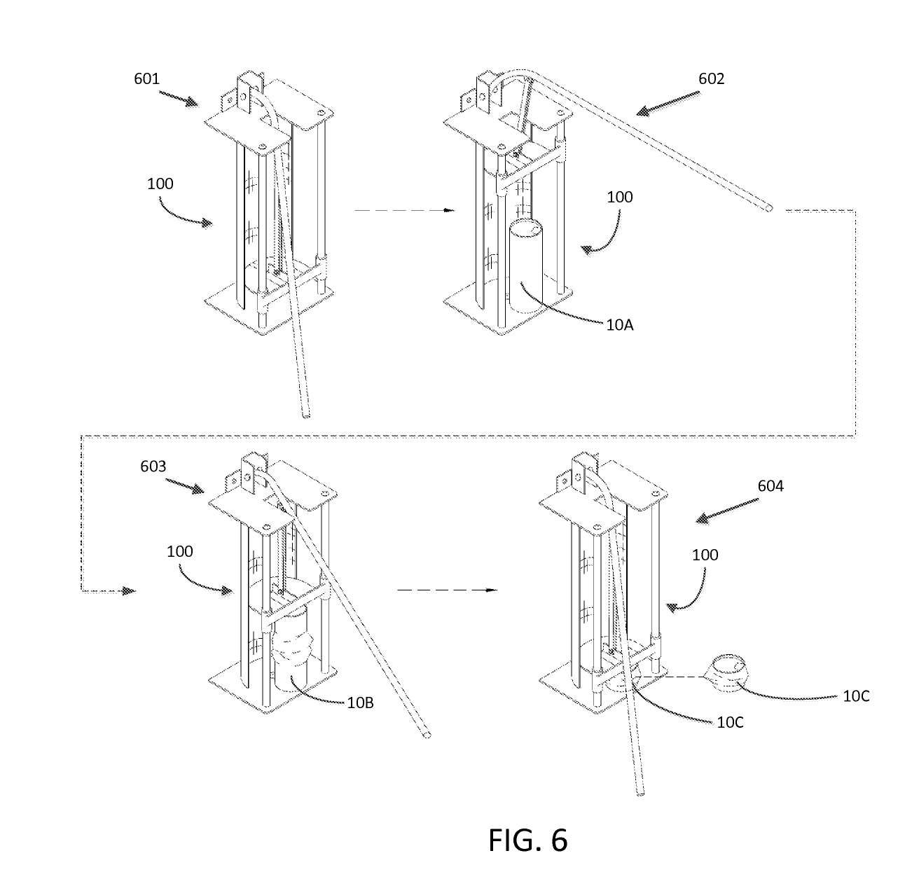

With reference now to the figures, and beginning with FIGS. 1-6, there is illustrated a first embodiment of the disclosed can compacting apparatus. Specifically, FIG. 1 is a perspective view generally illustrating the first embodiment of the disclosed apparatus, which is can compacting apparatus 100; FIG. 2 is an exploded view illustrating exemplary components of can compacting apparatus 100; FIGS. 3-5 are enlarged sectional views illustrating respective focused sections or members of can compacting apparatus 100; and FIG. 6 is a pictorial showing how can compacting apparatus 100 is operated to effectively compact a relatively larger can, such as a commercial 25-oz aluminum can.

Referring to FIG. 1, can compacting apparatus 100 is disposed vertically, with its pressure-exerting surface (hereinafter used interchangeably with “compacting surface”) slightly displaced from its top plate, as a result of a corresponding pivotal downward displacement of the distal end (operating end) of its extended lever. When in practical use, can-compacting apparatus 100 is usually vertically mounted against or fastened to a standing structure (e.g., a wall stud or a standing post) at an appropriate height, such that a human operator of a normal height can comfortably reach and grip the operating end of the lever with one or two hands when the pressure-exerting surface is slidably raised to either reach, or stay close to, the top plate thereof.

Referring to FIGS. 1, 2 and 3, a first plate member may be visually referred to as a top plate member, as can-compacting apparatus 100 is usually vertically disposed. In this embodiment, a top plate member may comprise a top plate 102 having a U-shaped cutout 131. Top plate 102 may be referred to interchangeably as a “top plate member” or “first plate member.” As shown, top plate 102 is generally of a symmetrical shape with respect to a centerline (not shown) extending from a distal length-wise edge to an opposing proximal length-wise edge otherwise uninterrupted by U-shaped cutout 131. Thus, U-shaped cutout 131 is also symmetrical with respect to the centerline.

U-shaped cutout 131 creates a U-shaped channel providing at least a couple of utilities. First, during an active can-compacting operation, the U-shaped channel receives linkage bars 107 and lets linkage bars 107 extend there-through, thus facilitating the can-compacting operation. Second, as shown in stage 601 of FIG. 6, when can compacting apparatus 100 is not in operation, the U-shaped channel receives lever 106 and lets lever 106 to extend there-through (as the compacting surface is lowered to either reach, or stay close to, bottom plate 103), thus letting can compacting apparatus 100 realize a most condensed or compressed space-saving configuration. Therefore, U-shaped cutout 131 is configured to have a depth (the length of its two parallel opposing side edges) deep enough and a width (the distance between the two parallel side edges) wide enough that can materialize both utilities. Hereinafter, “U-shaped channel 131” (or simply “channel 131) is used to refer to the U-shaped channel created by U-shaped cutout 131.

Top plate 102 may further have fastening holes 116A and 116B for fastening top plate 102 to guide rods 105A and 105B of a compacting-carriage member, with, e.g., fastening screws or bolts 116A and 116B, respectively. Fastening holes 116A and 116B are used to fasten the top plate member to a compactor-guiding member (which, in this embodiment, comprises guide rods 105A and 105B). Thus, fastening holes 116A and 116B are located based on and corresponding to the implementation and configuration of the compactor-guiding member. In this implementation, fastening holes 116A and 116B are each drilled near one of the two symmetrical proximal edge corners thereof, since these two drilled locations correspond to where guide rods 105A and 105B are respectively disposed when can-compacting apparatus 100 is fully assembled and deployed for operation.

Referring to FIGS. 1, 2 and 5, a second plate member may be visually referred to as a bottom plate member. In this embodiment, the bottom plate member comprises a bottom plate 103. Bottom plate 103 may be referred to interchangeably as a “bottom plate member” or “second plate member.” Shape-wise, bottom plate 103 may minor or correspond to top plate 102 when top plate 102 does not have the U-shaped cutout 131. Thus, like top plate 102, bottom plate 103 may also be generally of a symmetrical shape. Similar to top plate 102 in connection with means for coupling to a compactor-guiding member, bottom plate 103 may have fastening holes 118A and 118B each drilled near one of the two symmetrical proximal edge corners thereof, since these two drilled locations correspond to where guide rods 105A and 105B are respectively disposed when can-compacting apparatus 100 is fully assembled and deployed for operation. Bottom plate 103 may further comprise a pressure relief hole 133, which, as shown, may be situated at or near its diagonal center. Pressure relief hole 133 is used to relieve some of the air pressure—which otherwise would have been accumulated between compactor plate 104 and bottom plate 103 in a compacting chamber—during a normal can-compacting operation so as to facilitate the carrying out of the operation.

Referring to FIGS. 1 and 2, a base member may comprise base 101, which, in this embodiment, is inwardly curved to form a concave shape that creates an inner space. Base 101 may be referred to interchangeably as “base member.” Similar to top and bottom plates 102 and 103, base 101 may be generally of a symmetrical structure. Base 101 is joined to (fastened to) top and bottom plates 102 and 103 at base 101's top and bottom curved edges, respectively, such that base 101 and top and bottom plates 102 and 103 are each generally symmetrical with respect to a common vertical plane (not shown). With this configuration or similar configurations, base 101 and top and bottom plates 102 and 103 form an assembly that creates a compacting chamber where an aluminum can may be vertically disposed therein so as to be subject to a compacting operation.

In particular, the respective dimensions of base 101 and top and bottom plates 102 and 103 are configured to allow the compacting chamber to comfortably receive and accommodate a standing larger commercial can (larger than a 12-oz or 16-oz commercial can), such as a commercial 25-oz aluminum can. Thus, for example, the two long straight edges of base 101 are spaced larger than 3⅜″, which is the outside diameter of a commercial 25-oz can. Further, the two long straight edges of base 101 are tall enough to not only comfortably accommodate the height of a commercial 25-oz can but also leave enough vertical room needed for a full compaction of the 25-oz can.

Similarly, the respective dimensions of top and bottom plates 102 and 103 are configured corresponding to the dimensions of base 101. For example, the respective lengths of top and bottom plates 102 and 103 (which are parallel to a straight line segment perpendicular to and extending between the two vertical edges of base 101) are large enough to render the formed compacting chamber capable of comfortably accommodating the outside diameter (the width) of, for example, a commercial 25-oz can. The respective widths of top and bottom plates are also large enough to render the formed compacting chamber comfortably accommodating the outside diameter (the depth) of, for example, a commercial 25-oz can.

A skilled artisan readily appreciates that top and bottom plates 102 and 103, as well as base 101, do not have to have the respective shapes and/or structures shown in FIG. 2. They can be of any respective shapes and structures so long as they collectively form a compacting chamber that comfortably (effectively) accommodates a vertically disposed larger commercial can, such as a commercial 25-oz can, for a successful compacting operation.

Referring to FIGS. 1, 2 and 4A-B, a compactor member is configured to, inter alia, supply a compacting surface, receive a transmitted force, and use the received force to guidingly move the compacting surface. In this embodiment, a compactor member may comprise a compactor plate 104, a linkage connector 121, a guide moving part (including two guide movers 108A and 108B), and a guide-movers-link 109. Compactor plate 104, as shown, may comprise a curved edge and a straight edge collectively forming a closed contour symmetrical with respect to a centerline extending between the mid-point of the curved edge and the mid-point of the straight edge.

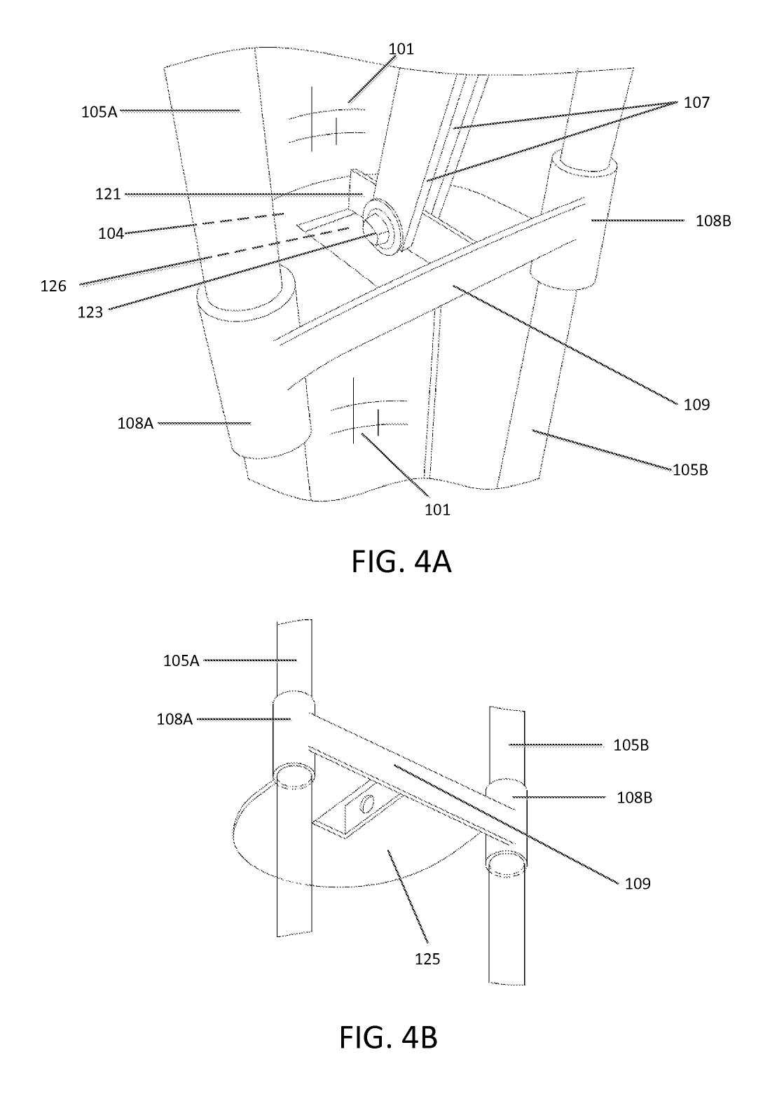

Compactor plate 104 may have an opening (shown as a slot) 126 carved out therein for pressure relief during a compacting operation. Opening 126 is generally narrow and small relative to the dimensions of compactor plate 104, and can be one of various possible shapes. In this embodiment, opening 126 is of a rectangular shape, and tangent to or nearly tangent to the centerline of compactor plate 104. Referring to FIG. 4B, the bottom surface 125 of compactor plate 104, which may be generally flat, is provided as the compacting surface that exerts force or pressure on an object (such as a commercial 25-oz can) disposed thereunder when compactor plate 104 is urged downward against the disposed object as a result of a received external force.

In this embodiment, a curved portion of the contour of compactor plate 104, which is disposed or partially disposed within the aforementioned inner space created by base 101, generally matches the aforementioned curved cross section of base 101. With this configuration, compactor plate 104 may move smoothly and effectively up and down the length of the compacting chamber with no friction (if, for example, the curved portion of the contour of compactor plate 104 does not meet the inner surface of base 104) or minimal friction. A skilled artisan appreciates that the contour of compactor plate 104 does not have to be curved so as to generally match a part of the horizontal cross section of base 101. Compactor plate 104 can be of any contour—in fact, compactor plate 104 can have a contour totally distinct from the horizontal cross section of base 101—so long as the contour allows compactor plate 104 to smoothly and effectively move up and down the length of the compacting chamber during a compacting operation.

Linkage connector 121 is coupled to compactor plate 104 by, for example, fixedly and perpendicularly joining to the top surface of compactor plate 104. Linkage connector 121 has a fastening hole 123, which is used to fasten or couple linkage connector 121 (and thus fasten or couple compactor plate 104) to a proximal end of linkage bars 107A and 107B using fastening (or retaining) elements 123 (which, as shown, may include a bolt or nut, one or more washers and/or lock washers), thereby linking compactor plate 104, and thus the compacting surface 125 of compactor plate 104, to linkage bars 107.

Two guide movers 108A and 108B are coupled to compactor plate 104 through guide-movers-link 109. As illustrated, in this embodiment, guide movers 108A and 108B are slidable sleeves over guide rods 105A and 105B for guiding movement of compactor plate 104 along guide rods 105A and 105B. In this embodiment, guide rods 105A and 105B are of a cylindrical structure. Thus, guide movers 108A and 108B may be also of a cylindrical structure so as to facilitate or enable their respective sliding along guide rods 105A and 105B. A skilled artisan readily appreciates that when guide rods 105A and 105B are of a different structure (e.g., other than a cylindrical structure), guide movers 108A and 108B may be configured accordingly to have a corresponding structure—for example, to have a non-sleeve structure—so long as the corresponding structure facilitates or enables their respective moving along guide rods 105A and 105B.

Further, collectively, two guide movers 108A and 108B may be referred to as a guide moving part of the compactor member. In other words, guide movers 108A and 108B, as a whole, is just one exemplary implementation of a guide moving part of the compactor member. The guide moving part may be implemented in various forms based on the structure of the compactor-guiding member—which can have various implementations and does not have to be implemented as two guide rods 108A and 108B—so long as the guide moving part enables the compacting surface to guidingly move along, or in accordance with, the compactor-guiding member.

Guide-movers-link 109 effectively links the compacting surface 125 of compactor plate 104 to guide movers 108A and 108B by on one hand joining to the straight edge of compactor plate 104 and on the other hand joining to both guide movers 108A and 108B. Thus, as the compacting surface 125 of compactor plate 104 is compelled to move by a received external force (as will be described in more details), with guide-movers-link 109 linking compactor plate 104 to guide movers 108A and 108B, guide movers 108A and 108B are compelled to slidably move accordingly on and along parallel guide rods 105A and 105B, respectively, thereby guiding the compacting surface 125 of compactor plate 104 to move either upwards or downwards along guide rods 105A and 105B.

As a skilled artisan readily appreciates, guide-movers-link 109 may be implemented in various forms in linking the compacting surface 125 of compactor plate 104 to guide movers 108A and 108B. In this embodiment, guide-movers-link 109 is shown as fixedly pre-joined to guide movers 108A and 108B with the respective two width-wise edges of guide-movers-link 109. In another implementation, guide-movers-link 109 may be a separate piece from guide movers 108A and 108B and may later on be joined to guide movers 108A and 108B and the straight edge of compactor plate 104. In yet another implementation, guide-movers-link 109 may be pre-joined to the straight edge of compactor plate 104 to form an assembly. The assembly may later on be joined to guide movers 108A and 108B with the respective two width-wise edges of guide-movers-link 109. In yet another implementation, compactor plate 104, guide-movers-link 109 and guide movers 108A and 108B may be pre-joined together to integrally form one piece of assembly configured to link compactor plate 104 (and therefore the compacting surface 125) to guide movers 108A and 108B, such that when compactor plate 104 is compelled to move, guide movers 108A and 108B is compelled to slidably move accordingly along parallel guide rods 105A and 105B, thereby guiding the compacting surface 125 of compactor plate 104 (and thus compacting surface 125) to move along guide rods 105A and 105B.

Referring to FIGS. 1, 2 and 3, a compactor-guiding member is structured and configured to allow the guide moving part of the compactor member to controllably move thereon and move there-along, thereby guiding movement of compactor plate 104 (when compactor plate 104 is compelled to move by a received external force or pressure). In particular, compactor-guiding member, working in conjunction with top and bottom plates 102 and 103, is configured to define a range where compactor plate 104 is allowed to move. In this embodiment, a compactor-guiding member comprises guide rods 105A and 105B. Guide rods 105A and 105B (or guide rods 105) collectively may be referred to interchangeably as a “compactor-guiding member.”

Guide rods 105A and 105B stand parallel to each other and parallel to the two vertical edges of base 101 and extends between top and bottom plates 102 and 103, with their respective top ends coupled to top plate 102 through coupling means 116 and their respective bottom ends coupled to bottom plate 103 through coupling means 118. Thus, guide rods 105A and 105B are generally equal in length to the two vertical edges of base 101. In one implementation, the inner vertical edges of guide rods 105A and 105B may substantially flush with the two vertical edges of base 10, respectively. Hence, guide rods 105A and 105B are spaced by generally the same distance as the two vertical edges of base 101.

As a skilled artisan readily appreciates, the compactor-guiding member does not have to be implemented as two guide rods, such as guide rods 105A and 105B. The compactor-guiding member may be implemented in various other forms—for example, the compactor-guiding member may be implemented as one, three or four guide rods—so long as the compactor-guiding member is configured to allow the corresponding guiding moving part of the compactor member to controllably move thereon and move there-along, thereby realizing the objective of enabling compactor plate 104 (and thus the compacting surface 125) to move guidingly.

Referring to FIGS. 1, 2 and 3, a lever member is structured and configured to generate a force—which, in most cases, is a very big force otherwise unattainable by releasing a human operator's internal energy—ultimately used to compel a compacting surface of the compactor member to move upwards and downwards with a great force so as to effectively compact a commercial can disposed thereunder. In this embodiment, a lever member comprises lever 106 and linkage connector 113.

As shown, lever 106 has a curved (angled) portion at the lever's proximal end and a straight portion extending from the curved portion to the lever's distal end. The curved portion of lever 106 is angled downward (or slightly downward) so as to prevent the straight portion of lever 106 from going all the way upwards. In other words, this angling or curvature results in the straight portion of the lever being angled such that an extension of the straight portion would not easily render a distal portion of the lever unreachable by a hand of a normal-height human operator when can-compacting apparatus 100 is vertically disposed (against a wall stud or a standing post) at a normal height that allows a normal-height human operator to easily access the compacting chamber. Additionally, lever 106 has a fastening hole 115 (as part of fastening means 115) near the proximal end of lever 106 (which is also the proximal end of the curved portion of lever 106). Fastening hole 115 of lever 106 is used to couple lever 106 to a lever-anchoring member with fastening means 115.

As a skilled artisan appreciates, although lever 106 is shown as a shaft having a curved portion and a straight portion, lever 106 may be implemented in various other forms. As one example, instead of being pre-made as one piece, lever 106 may be made of several segment pieces. These segment pieces may be joined to form the curved (angled) portion and/or the straight portion, and finally the entirety of lever 106 (via, for example, their respective flanges). As another example, the current curved portion of lever 106 may be modified by angling the portion differently from what is shown in FIGS. 1, 2 and 3. As yet another example, the current straight portion of lever 106 may be replaced by a combination of angled (curved or slightly curved) segments and straight segments. Also, lever 106 may be implemented in a different form from that shown herein (namely, the shaft). For example, lever 106 may be implemented as a “pull handle” assembly (having, for example, two long extension bars and one horizontal gripping bar).

Linkage connector 113 of the lever member is structured and configured to connect or couple lever 106 to a lever-to-compactor member. In this embodiment, linkage connector 113 is a fastening piece joined to lever 106 at a location on the lever 106 that is suitable for generating a force much bigger than an original human force applied on the distal end (operating end) of lever 106 (as a result of the original human force being continuously applied on the distal end of lever 106 over the length of a pivotal displacement of the distal end) and transmitting the generated force to the compactor member via the lever-to-compactor member. As shown, linkage connector 113 has one or more fastening holes 114 (as part of coupling or fastening means 114), which are configured to allow fastening means 114 to fasten linkage bars 107 (of the lever-to-compactor member) to the linkage connector 113 itself.

In one implementation, linkage connector 113 is joined to lever 106 at approximately where the curved portion of lever 106 meets the straight portion of lever 106. In other implementations, linkage connector 113 may be joined to lever 106 at other locations on lever 106 so long as the combination of linkage connector 113 and lever 106 helps to generate a force much bigger than the original human force applied on the distal end of lever 106 and enable the generated force to be effectively transmitted to the compactor member via the lever-to-compactor member. Additionally, although linkage connector 113 is shown as a separate piece, linkage connector 113 may be implemented as an integral part of lever 106. For example, linkage connector 113 may be implemented as a protrusion (for example, with a fastening hole) formed on lever 106.

Referring to FIGS. 1, 2 and 3, a lever-anchoring member is structured and configured to pivotally anchor the lever member (particularly a lever of the lever member) with respect to the compacting chamber. In this embodiment, a lever-anchoring member may comprise a U-channel bracket 112 having a base part and two generally parallel opposing side parts. U-channel bracket 112 may be referred to interchangeably as a “lever-anchoring member.” As shown, each of the two opposing side parts has a fastening hole 115 situated at or near the diagonal center thereof. The two respective fastening holes 115 of the two opposing side parts are correspondingly situated so that a fastening pin 115 may extend from the fastening hole on one side part to the fastening hole on the other side part, with the fastening pin 115 positioned generally parallel to the base part and perpendicular to the two opposing side parts. The proximal end of lever 106 is received in the U-channel of U-channel bracket 112 (since the channel created by U-channel bracket 112 has a U-shaped cross section taken along a horizontal plane perpendicular to both side parts).

In particular, fastening pin 115, in connecting the two fastening holes 115 of the two opposing side parts, extends through fastening hole 115 of lever 106 near the proximal end of lever 106, thereby anchoring (coupling) the proximal end of level 106 to U-channel bracket 112, when both ends of fastening pin 115 are fastened to the respective two side parts through the two fastening holes 115 thereof with known fastening elements 115 (such as one or more bolts or nuts). In anchoring the proximal end of lever 106, U-channel bracket 112 anchors lever 106 with respect to the compacting chamber formed by top plate 102, base 101 and bottom plate 103, so that when, for example, can-compacting apparatus 100 is not in use, lever 106 may, as shown in stage 601 of FIG. 6, extend through U-channel 131 of top plate 102 as the distal end of lever 106 is displaced to a maximum stop position (in realizing a most condensed or compressed space-saving configuration of can-compacting apparatus 100). Thus, in this embodiment, U-channel bracket 112 is fixedly disposed relative to the compacting chamber.

FIG. 3 illustrates an exemplary configuration in which U-channel bracket 112 is fixedly disposed relative to the compacting chamber. Referring to FIG. 3, U-channel bracket 112 is fixedly joined to the top surface of top plate 102, with both the respective bottom edges of the two side parts and the bottom edge of the base part joined to the top surface of top plate 102. The bottom edge of the base part generally flushes with the length-wise distal edge of top plate 102. Additionally, the two opposing side parts may be generally symmetrical to each other with respect to the vertical plane defined by the aforementioned centerline of top plate 102 and the vertical centerline extending between the top and bottom edges of the base part.

As a skilled artisan appreciates, configurations other than the one shown in FIG. 3 may also allow U-channel bracket 112 to effectively anchor the proximal end of lever 106 relative to the compacting chamber. As one example, U-channel bracket 112 does not have to be so disposed that the bottom edge of the base part of U-channel bracket 112 generally flushes with the length-wise distal edge of top plate 102. Instead, U-channel bracket 112 may be disposed slightly inside, and thus clear of, the length-wise distal edge of top plate 102, while still allowing lever 106 to extend through U-channel 131 of top plate 102 (so as to realize a most compressed space-saving configuration). As another example, in one configuration, U-channel bracket 12 may even be disposed slightly above top plate 102 against a standing structure (such as a wall stud) while still allowing lever 106 to extend through U-channel 131 of top plate 102 (in realizing a most condensed space-saving configuration). In particular, the base part of U-channel bracket 112 may contain one or more fastening holes (not shown) or other mounting means (not shown) that can be used to fasten or mount U-channel bracket 112 against the standing structure. Thus, using the one or more fastening holes (or other mounting means), U-channel bracket 12 may be disposed slightly above (and thus clear of and separate from) the top surface of top plate 102 when U-channel bracket 12 is separately mounted against the same standing structure (against which the rest of can-compacting apparatus 100 is securely mounted) and slightly away from the rest of can-compacting apparatus 100.

As shown, fastening pin 115 fastens the proximal end of lever 106 (which is also the proximal end of the curved portion of lever 106) to U-channel bracket 112 by extending through fastening hole 115 of lever 106 (which is near the proximal end of the curved portion of lever 106) as the proximal end of the curved portion is received ins the U-channel of U-channel bracket 112. With this configuration, the distal end of lever 106 can pivot about the fastening pin and move its distal end generally vertically between a maximum release position and a maximum stop position. A pivotal displacement of the distal end of lever 106 results in a corresponding guided displacement of the compactor member (particularly, the compacting surface 125 of compactor plate 104) along guide rods 105A and 105B through a lever-to-compactor linkage member.

Referring to FIGS. 1, 2, 3 and 4A, a lever-to-compactor linkage member is structured and configured to link the lever member to the compactor member in such a manner that a force can be generated (at where the lever-to-compactor linkage member is coupled to lever 106) as a result of, inter alia, an original force (usually a human force) being continuously applied onto the distal end of lever 106 over the length of a resulting displacement of the distal end, and the generated force is transmitted from the lever member to the compactor member (as reflected by, for example, a resulting guided displacement of the compacting surface 125 of compactor plate 104). In this embodiment, a lever-to-compactor linkage member may comprise two linkage bars 107A and 107B. Linkage bars 107A and 107B (or linkage bars 107) collectively may be interchangeably referred to as a “lever-to-compactor linkage member.”

In one implementation, linkage bars 107A and 107B links the lever member (particularly, lever 106) and the compactor member (particularly compactor plate 104 and thus the compacting surface 125 of compactor plate 104) through their respective linkage connectors 113 and 121. The respective proximal ends of linkage bars 107 are fastened to fastening hole 123 of linkage connector 121 (of the compactor member) with known fastening means 123. The respective distal ends of linkage bars 107 are fastened to one or more fastening holes 114 of linkage connector 113 (of the lever member) with known fastening means 114. Additionally, during an active can-compacting operation, linkage bars 107 may extend from the lever member to the compactor member through U-channel 131 of top plate 102.

The lever member, the lever-to-compactor member and the compactor member collectively work in concert to generate and transmit a big enough force to compactor plate 104 that allows the compacting surface 125 of compactor plate 104 to adequately overcome the resistance from a commercial can (such as a commercial 25-oz aluminum can) disposed thereunder and fully compact the disposed can during a can-compacting operation.

Specifically, with linkage bars 107 coupled to the two linkage connectors 113 and 121 at the two respective ends thereof, due to the relatively short distance of linkage connector 113 from the pivoting point (namely, the proximal end of lever 106), the distance of the linkage bars 117 from the pivoting point is a fraction of the distance of the distal end of lever 106 from the pivoting point. Thus, a downward force generated as a result of, inter alia, an original downward force (usually human force) being continuously applied onto the distal end of lever 106 over the length of a resulting displacement of the distal end, is usually a multiple of, and thus much greater than, the original downward force.

Also, with linkage bars 107A and 107B coupled to both lever 106 and compactor plate 104 through their respective linkage connectors 113 and 121, the generated downward force is transmitted to compactor plate 104. Assuming that an original force (which is usually a human force) applied to the distal end of lever 106 is within a reasonably predictable range, the length of lever 106, to a great extent, determines how big of a force compactor plate 104 (through its bottom surface 125) can urge against the top surface of a target commercial can (disposed thereunder in the compacting chamber) subject to a compacting operation. In one embodiment, the length between the proximal and distal ends of the lever is set at 23″. Applicant confirms that letting lever 106 have this length (23″) may result in a force big enough to allow the compacting surface 125 of compactor plate 104 compact not only a commercial 25-oz can, but even a commercial 32-oz can. As a skilled artisan appreciates, lever 106 may be of other lengths (which can be either longer or slightly shorter than 23″), as long as a displacement of the distal end of lever 106 can result in the compacting surface 125 of compactor plate 104 generating a compacting force big enough to effectively compact a target object subject to the compacting operation (such as a commercial 25-oz can).

Referring to FIGS. 1, 2, 3 and 5, a mounting member is structured and configured to mount can compacting apparatus 100 against a standing structure (such as a wall stud or a standing post). In this embodiment, the mounting member may at least comprise mounting pieces 135A, 135B and 135C. Additionally, when U-channel bracket 112, as shown in FIG. 3, is joined to the top surface of top plate 102 with the bottom edge of its base part generally flushing with the distal length-wise edge of top plate 102, the base part of U-channel bracket 112 (or in other words, U-channel bracket 112) may also be part of the mounting member when the base part contains a mounting hole (not shown) and the mounting hole ends up being used to mount can compacting apparatus 100 against the standing structure.

Each of mounting pieces 135A, 135B and 135C is a rectangular piece having a mounting hole 111 at or near its diagonal center. Mounting piece 135C may be joined to the bottom surface of bottom plate 103 along the distal length-wise edge of bottom plate 103. Mounting piece 135C may be situated perpendicular to bottom plate 103 and symmetrical with respect to the vertical plane defined by the vertical centerline of mounting piece 135C and the centerline of bottom plate 103 parallel to the aforementioned centerline of top plate 102. Can compacting apparatus 100 may be made of metal sheet and/or steel. For example, lever 106 and guide rods 105 may be made of lightweight steel, and the rest of the components, such as base 101, top and bottom plates 102 and 103, and compactor plate 104, may be made of lightweight metal sheets. So can compacting apparatus 100 is usually lightweight, weighing, for example, only around 4½ pounds. Thus, when U-channel bracket 112 is used as a part of the mounting member, mounting hole 111 and the mounting hole on the base part of U-channel bracket can be collectively used to effectively mount the entire can compacting apparatus against a wall stud using known mounting or fastening means (such as one or more screws, bolts or nuts). In fact, Applicant confirms that usually only two normal screws (one used with mounting hole 111 of mounting piece 135C and one used with the aforementioned mounting hole of the base part of U-channel bracket) are needed to securely and effectively mount the entire compacting apparatus 100 against a wall stud.

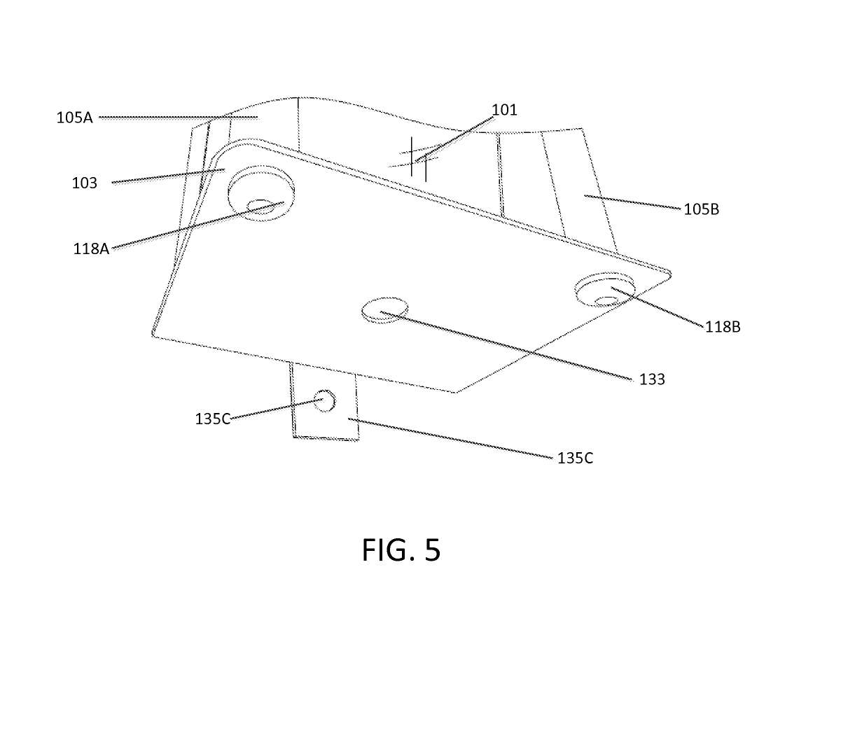

As shown, mounting pieces 135A and 135B are joined to the top surface of top plate 102 along the distal length-wise edge of top plate 102. Mounting pieces 135A and 135B are situated perpendicular to the top surface of top plate 102 and symmetrical with respect to the aforementioned centerline of top plate 102. Mounting pieces 135A and 135B may be spaced such that their respective mounting holes 111 are spaced by approximately 4 inches. In the same token, two identical or similar bottom mounting pieces (not shown) may be joined to the bottom surface of bottom plate 103 in a manner similar to the manner that mounting pieces 135A and 135B are joined to the top surface of top plate 102 (except that these two bottom mounting pieces is situated under the bottom surface of bottom plate 103). These two bottom mounting pieces may be in addition to or in place of the mounting piece 135C shown in FIGS. 2 and 5. With these two bottom mounting pieces and the two top mounting pieces 135A and 135B, the entire compacting apparatus can be securely and effectively be mounted against a 4×4 standing post by applying known mounting or fastening means to the respective mounting holes thereof.

As a skilled artisan appreciates, the mounting member does not have to be implemented as what has been described above and shown in FIGS. 1, 2, 3 and 5. In fact, the second embodiment, which will be described below uses an alternative implementation with regard to the mounting member. Thus, the mounting member can be implemented in various other forms, so long as the mounting member can work in concert with the standing structure (against which the mounting is carried out) to realize a secure mounting of the entire can compacting apparatus 100 against the standing structure so that a normal can compacting operation can be effectively carried out with can compacting apparatus 100.

FIG. 6 is a pictorial illustrating a sequence of operations performed to compact a commercial 25-oz can using the disclosed can compacting apparatus 100. Referring to FIG. 6, at state 601, can compacting apparatus 100 is vertically disposed (mounted) in its idle configuration, with lever 106 extending through U-shaped channel 131 of top plate 102. In this idle configuration, the distal end of lever 106 has pivotally displaced to a maximum stop position, resulting in compactor plate 104 being lowered to either reach, or stay close to, the top surface of bottom plate 103. In particular, a maximum stop position for the distal end of lever 106 is defined as the displacement position of the distal end of lever 106, at which compactor plate 104 is lowered to either reach, or stay close to, the top surface of bottom plate 103, and can no longer be lowered any further. For can compacting apparatus 100, this idle configuration may also be referred to the most condensed (compressed) space-saving configuration, since can compacting apparatus 100 occupies the least usable space at this configuration.

At stage 602, the distal end of lever 106 has pivotally displaced from the maximum stop position to either a maximum release position or a position close to the maximum release position. In particular, a maximum release position for the distal end of lever 106 is defined as the displacement position of the distal end of lever 106, at which compactor plate 104 is raised to either reach, or stay close to, the bottom surface of top plate 102, and can no longer be raised any further. Also, at stage 602, a target commercial can (to be compacted), such as a commercial 25-oz aluminum can 10, has been disposed in its upright position in the compacting chamber. As noted above when describing the compacting chamber, the compacting chamber is structured and configured to have dimensions large enough to have a relatively larger can (such as a commercial 25-oz can) vertically disposed therein. Thus, with can compacting apparatus 100, there is no issue in regard to placing, for example, a commercial 25-oz can for a compacting operation. At this stage, aluminum can 10 is referred to as “10A”, indicating that aluminum can 10 is in an uncompacted or undeformed state.

At stage 603, an original downward force is exerted (usually by a human operator) onto the distal end of lever 106 to operate the distal end of lever 106 to move downward. This original downward force continues over the length of a resulting pivotal displacement of the distal end of lever 106, with the proximal end of lever 106 being the pivoting point. Thus, a torque is produced as a result of, inter alia, the downward force being applied over the length of the pivotal displacement of the distal end of lever 106. This torque generates a corresponding downward force—which, as noted above, is much bigger than the original downward force exerted onto the distal portion of lever 106—at the distal ends of linkage bars 107 (where linkage bars 107 is coupled to linkage connector 113). The generated downward force, via linkage bars 107, is transmitted to compactor plate 104 in the form of turning into a downward force exerted on compactor plate 104.

The downward force exerted on compactor plate 104 results in bottom surface 125 of compactor plate 104 urging downward against the vertically disposed aluminum can 10 along the two guide rods 105A and 105B. The downward urging of bottom surface 125 (of compactor plate 104), when resisted by aluminum can 10 vertically disposed there-below, results in a downward counterforce (produced by bottom surface 125) against aluminum can 10—which, due to physics principles, may be equal to or close to the downward force exerting on compactor plate 104, and thus is much greater than the original downward force exerted on the distal end of lever 106—being exerted on the top surface of the vertically disposed can 10. The downward urging force (or counterforce) exerted on aluminum can 10 eventually exceeds a threshold level required to overcome the resistance of the 25-oz aluminum can 10. As a result, aluminum can 10 becomes deformed and partially compacted in the downward direction, which allows compactor plate 104 to move further downward (along guide rods 105) so as to further compact aluminum can 10. At this stage, aluminum can 10 is referred to as “10B”, which indicates that aluminum can 10 is in deformed and partially compacted state.

At stage 604, the downward urging of compactor plate 104 on aluminum can 10 continues until the aluminum can is in such a fully compacted stated that the downward urging force on the aluminum can no longer overcome the counterforce generated by the aluminum can to resist further compaction. At this stage, aluminum can 10 is referred to as “10C”, indicating that aluminum can 10 is in a fully compacted state. At this time, the distal end of lever 106 may be operated to pivotally move upward, resulting in compactor plate 104 to move upward accordingly, so that enough room above the fully compacted can 10C is created for the human operator to remove the compacted can 10C from the compacting chamber (for recycling).

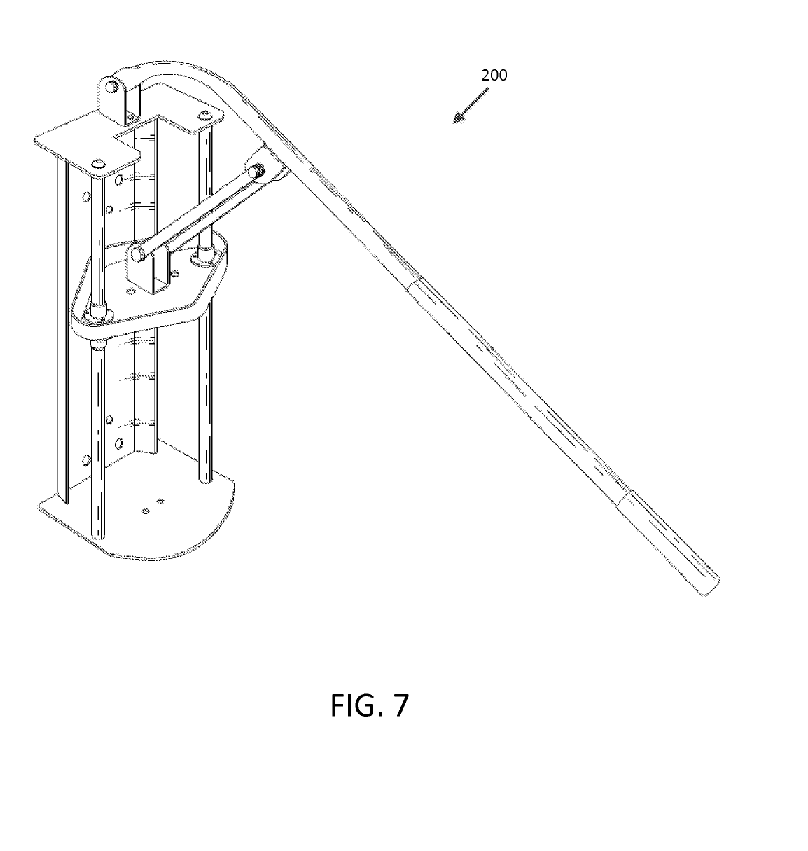

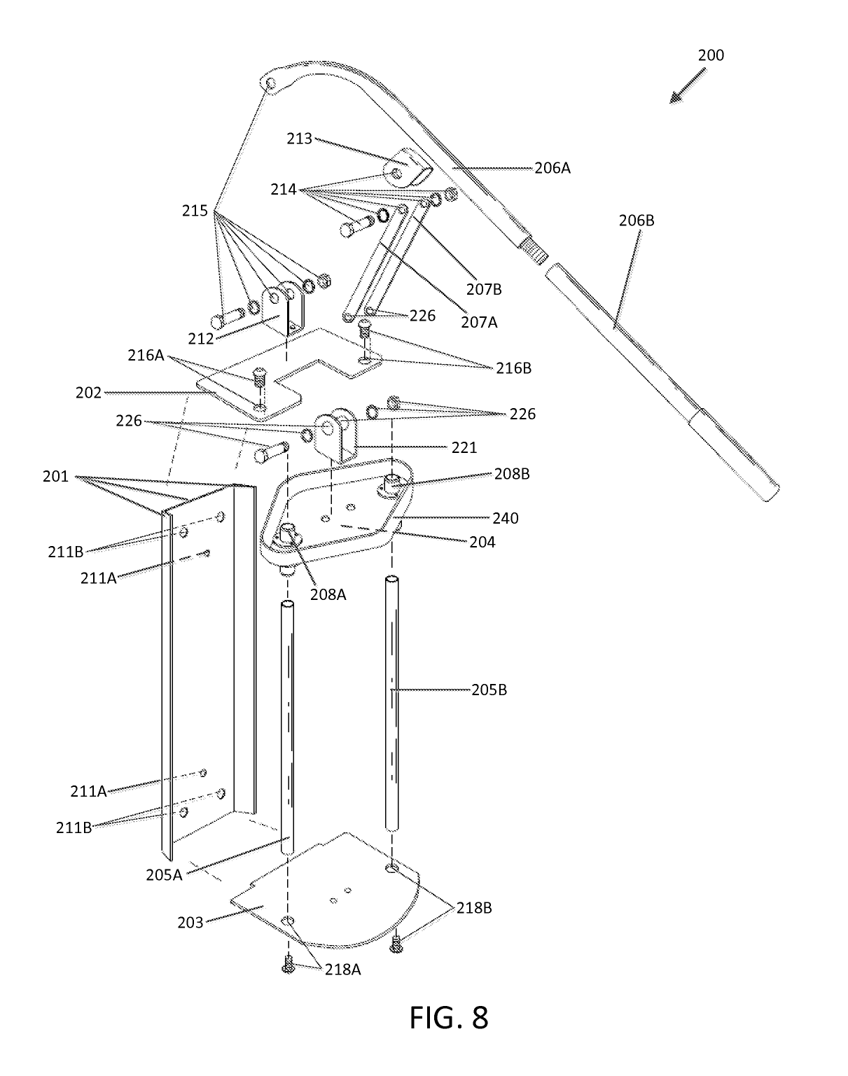

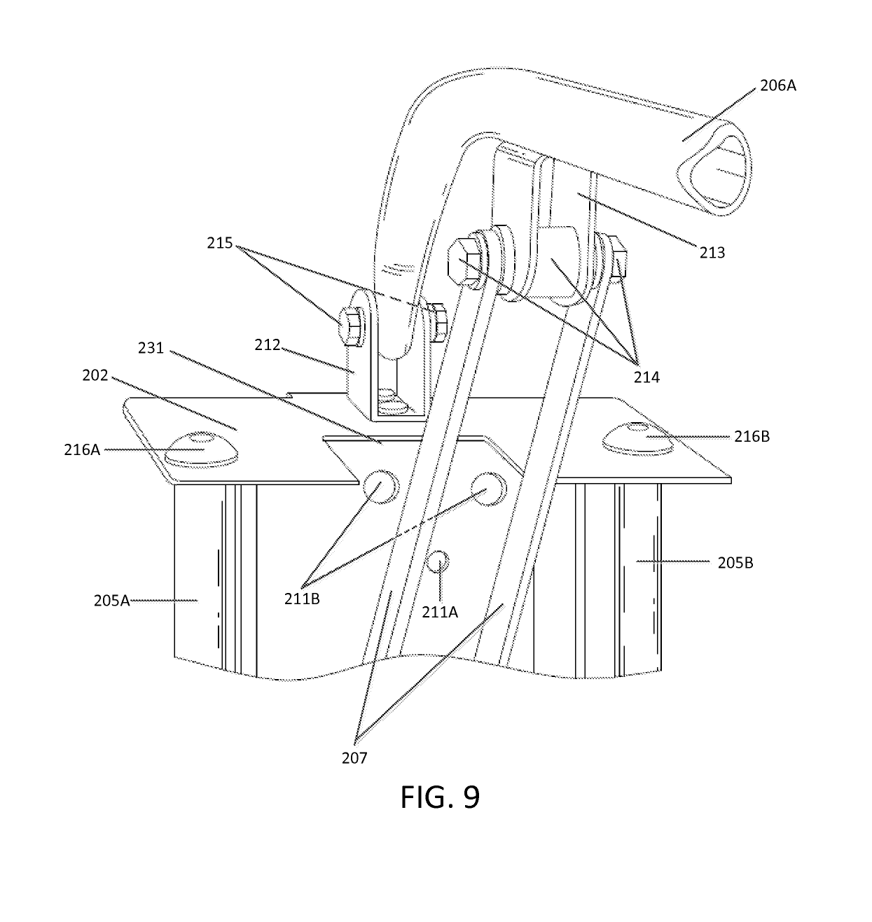

FIGS. 7-11 illustrate a second embodiment of the disclosed can compacting apparatus (namely, can compacting apparatus 200), which is configured similarly to the first embodiment (namely, can compacting apparatus 100) illustrated in FIGS. 1-5. FIGS. 7-11 are drawn and arranged to illustrate the second embodiment in a manner similar to that of FIGS. 1-5 used to illustrate the first embodiment. Specifically, FIG. 7 is a perspective view generally illustrating can compacting apparatus 200; FIG. 8 is an exploded view illustrating exemplary components of can compacting apparatus 200; and FIGS. 9-11 are enlarged sectional views illustrating focused sections or members of can compacting apparatus 200.

Since can compacting apparatus 200 (the second embodiment) is configured similarly to can compacting apparatus 100 (the first embodiment)—they both comprise a first plate member, a base member, a second plate member, a compactor member, a lever member, a lever-anchoring member, a lever-to-compactor linkage member, a compactor-guiding member, and a mounting member—the specific descriptions of the configurations of can compacting apparatus 200 are not given detailed discussion except for specific configurations that are different from those of can compacting apparatus 100. Additionally, to facilitate comparing components of can compacting apparatus 200 to corresponding counterpart components of can compacting apparatus 100 (which have already been described and discussed), components of can compacting apparatus 200 are assigned reference numerals or reference alpha-numerals having the same tenth and single digits as those of reference numerals or reference alpha-numerals assigned to corresponding counterpart components of can compacting apparatus 100, respectively. For example, “203” is assigned to the bottom plate of can compacting apparatus 200, in consideration of that “103” is assigned to the bottom plate of can compacting apparatus 100.

For can compacting apparatus 200, the first (top) plate member (namely, top plate 202), the compactor-guiding member (namely, guide rods 205A and 205B), the lever-to-compactor linkage member (namely, linkage bars 207A and 207B) are same or very similar to their respective counterpart members of can compacting apparatus 100 in terms of implementation. Thus, descriptions and discussions on these members of can compacting apparatus 200 are omitted.

Referring to FIG. 8, the base member of can compacting apparatus 200, namely base 201, has a slightly different shape from that of base 101 of can compacting apparatus 100. Base 201 has a generally flat rectangular part in the middle and two side rectangular parts obliquely joined to the middle piece along the two long side edges of the middle part. With the two side parts are inclined inward, the middle part and the two side parts collectively form a concave shape which creates an inner space similar to the inner space created by base 101 of can compacting apparatus 100.

One consideration of using base 201 as the base member (or part of the base member) is that the mounting member of can compacting apparatus 200 no longer requires to use one or more separate mounting pieces (like separate mounting pieces 135A, 135B and 135C of can compacting apparatus 100). In this embodiment, because the middle part of base 201 is flat, the middle part is suitable to have mounting holes. Specifically, the middle part of base 201 has two mounting holes 211B near the top edge thereof and a single mounting hole 211A slightly below the two mounting holes 211B. In one implementation, the single mounting hole is on the vertical centerline extending from the top edge of the middle piece to the bottom edge of the middle piece, and the two mounting holes 211B are aligned parallel to the top and bottom edges of the middle piece and symmetrical with respect to the vertical centerline. The two mounting holes 211B may be spaced by approximately 4 inches.

Similarly, the middle piece of base 201 has two mounting holes 211B near the bottom edge thereof and a single mounting hole 211A slightly above the two mounting holes 211B near the bottom edge. Thus, the single mounting hole 211A near the top edge and the single mounting hole 211A near the bottom edge can be used to securely mount the entire can compacting apparatus 200 against a standing structure such as a wall stud, and the two mounting holes 211B near the top edge and two mounting holes 211B near the bottom edge can be used to securely mount the entire can compacting apparatus 200 against a standing structure such as a 4×4 standing post. Hence, the mounting member of can compacting apparatus 200, instead of comprising separate mounting pieces, simply includes mounting holes 211A and 211B drilled on the middle part of base 201.

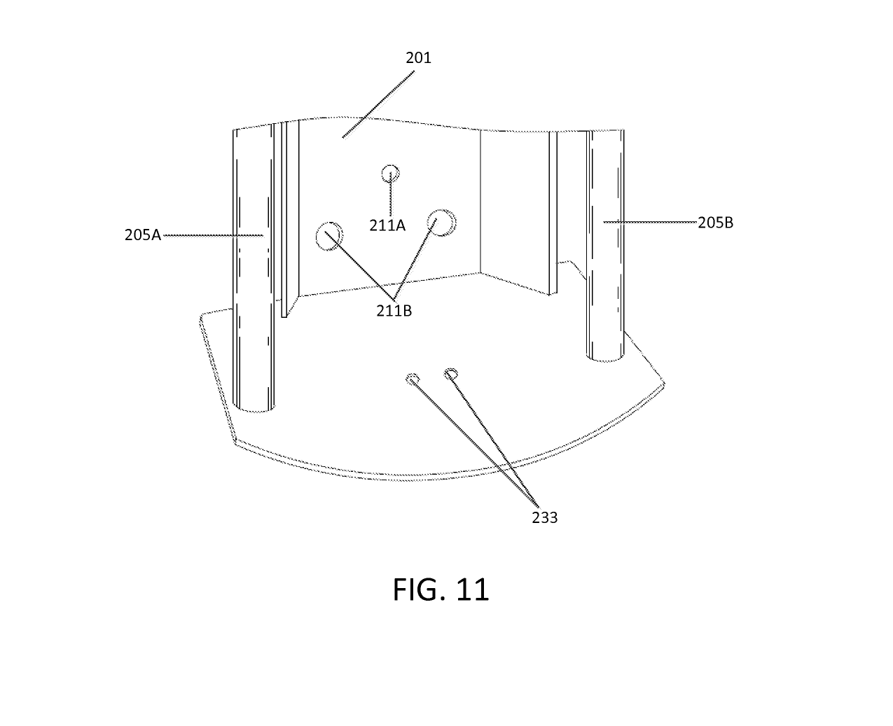

The bottom plate member of can compacting apparatus 200, namely, bottom plate 203, may have a slightly different shape from that of bottom plate 103 of can compacting apparatus 100. Referring to FIGS. 8 and 11, bottom plate 203 may have a curved proximal length-wise edge. Also, instead of having one pressure relief hole situated at the diagonal center (as is the case for bottom plate 103 of can compacting apparatus 100), bottom plate 203 has two small pressure relief holes 233 situated symmetrical with respect to its diagonal center.

The lever-anchoring member of can compacting apparatus 200, namely, U-channel bracket 212, is used slightly differently from U-channel bracket 112 of can compacting apparatus 100. Referring to FIG. 9, unlike can compacting apparatus 100 where U-channel bracket 112 is joined to the top surface of top plate 102 via the respective bottom edges of the two parallel opposing side parts of U-channel bracket 112 (as U-channel bracket 112 pivotally anchors lever 106), can compacting apparatus 200 uses U-channel bracket 212 to anchor lever 106 by joining the entire base part of U-channel bracket 212 to the top surface of top plate 202.

The lever member of can compacting apparatus 200 is similar to that of can compacting apparatus 200 except that lever 206 of the former is not pre-built as one piece, but instead built of two pieces 206A and 206B by having piece 206A joined to piece 206B using the their respective flanges.

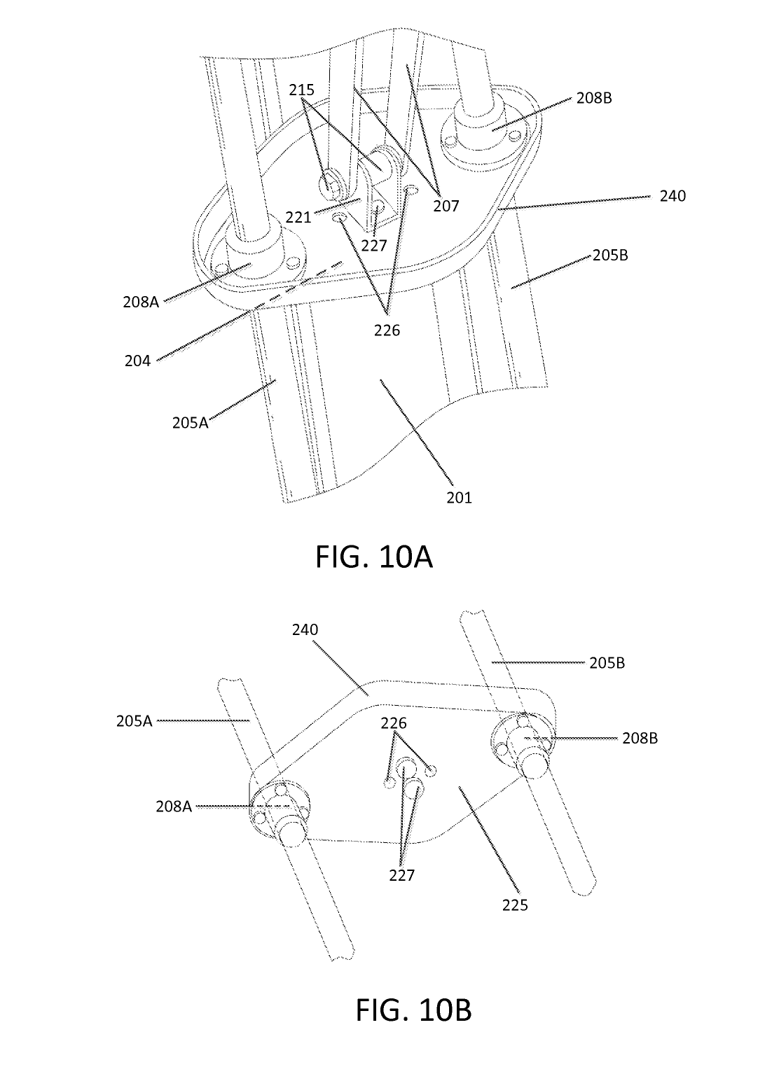

The compactor member of can compacting apparatus 200 is implemented slightly differently from the compactor member of can compacting apparatus 100. Referring to FIGS. 8, 10A and 10B, the compactor member of can compacting apparatus 200 is implemented as an integrated assembly—namely, compactor assembly 240 which comprises components similar to the components of the compactor member of can compacting apparatus 100. For example, compactor assembly 240 comprises main plate part 204, guide movers 208A and 208B, and linkage connector 221. Similar to compactor plate 104 (which is of a symmetrical shape, has slot 126 for pressure relief, and is joined to a linkage connector), main plate part 204 is also of a symmetrical shape, has two apertures 226 for pressure relief, and is joined to linkage connector 221. Also, similar to compactor plate 104 (whose bottom surface 125 is provided as the pressure-exerting surface), main plate part 204 also has its bottom surface 225 provided as the pressure-exerting surface.

Some components of compactor assembly 240 are implemented slightly differently from their counterpart components of the compactor member of can compacting apparatus 100. For example, main plate part 204 has a different contour and different dimensions from those of compactor plate 104 of can compacting apparatus 100. In particular, although compactor assembly 240 does not have a separate link (used to link two guide movers to the compacting surface) that is similar to guide-movers-link 109 of can compacting apparatus 100 (which is used to link guide movers 108 to the compacting surface 125), main plate part 204 of compactor assembly 240, in addition to providing a compacting surface, is configured to effectively link two guide movers (namely, guide movers 208A and 208B) to the compacting surface (namely, the compacting surface 225).

Plane-wise, main plate part 204 spans across an area that extends beyond two guide rods 205A and 205B (when compactor assembly 240 is incorporated into can compacting apparatus 200), and provides coupling means to couple guide movers 208A and 208B there-within. In particular, main plate part 204 provides two coupling holes (not shown) at locations configured to receive (extend) guide rods 205A and 205B there-through. Each of guide movers 208A and 208B includes a ring-shaped flange pressure-fitting against an inner cylindrical sleeve part. As shown, the respective ring-shaped flanges are used to fasten guide movers 208A and 208B to main plate part 204. With this configuration, main plate part 204 effectively links the two guide movers 208A and 208B to the compacting surface 225 (which is the bottom surface of main plate part 204).

Linkage connector 221, unlike linkage connector 121 of can compacting status 100, is implemented using a U-channel bracket (which hereinafter will be referred to as “U-channel bracket 221”). The base part of U-channel bracket 221 is fastened to the top surface of main plate part 204 via fastening buttons 227. Fastening buttons 227 may slightly protruded from the compacting surface 225 of main plate part 204. As long as the protrusion is not excessive, the presence of the protrusion in the compacting surface 225 usually does not affect the compacting surface 225 to exert a big enough force or pressure on an aluminum can disposed thereunder for can-compacting purpose. The fastening holes on the two parallel opposing side parts of u-channel bracket 221 are used to fasten linkage bars 207 to U-channel bracket 221, and thus to main plate part 204.

Thus, main plate part 204 also effectively links guide movers 208 (forming a guide moving part) to linkage connector 221, thereby enabling guide movers 208A and 208B to guide movement of main plate part 204 by respectively sliding along guide rods 205A and 205B when main plate part 204 is compelled to move as a result of receiving a force transmitted from lever 206 via linkage connector 221 and linkage bars 207.

With the above disclosures, it can be seen that the disclosed can compacting apparatus provides advantages not otherwise possessed by conventional lightweight can compacting apparatuses. Namely, the disclosed can compacting apparatus not only is lightweight, easy to operate and easy to mount, but also has the capability to generate a big enough force to fully compact not only regular 12-oz or 16-oz commercial cans, but also relatively larger and widely used commercial cans, such as 25-oz or 32-oz commercial cans.

While the disclosure has been described with reference to exemplary embodiments, it will be understood by those skilled in the art, and it is clearly demonstrated through the second embodiment, that various changes may be made and equivalents may be substituted for elements thereof without departing from the scope of the disclosure. In addition, many modifications may be made to adapt a particular system, device or component thereof to the teachings of the disclosure without departing from the essential scope thereof.

For example, although during the discussion on the disclosed can-compacting apparatus, a commercial 25-oz can is used as an example of relatively larger cans and the compacting chamber is disclosed to be configured to receive and accommodate a vertically disposed 25-oz can for can-compacting purpose. For the compacting chamber to receive and accommodate a vertically disposed commercial can that is even larger than a 25-oz can, the assembly forming the compacting chamber (which includes the top and bottom plate members and the base member) may incorporate known adjustable means to adjust the dimensions of the compacting chamber. Additionally, the apparatus may incorporate adjustable means to adjust, e.g., the spacing between the two guide rods, the dimensions of the compactor plate and the length of the lever, so as to enable the apparatus to effectively compact the disposed larger commercial can. These modifications and similar modifications involving incorporating adjustable means do not depart from the spirit and the scope of the present disclosure.

Therefore, it is intended that the disclosure not be limited to the particular embodiments disclosed for carrying out this disclosure, but that the disclosure will include all embodiments falling within the scope of the appended claims.

What is claimed is:

1. A can compact apparatus, comprising:
a compacting chamber assembly including a first plate member, a base member having a concave shape, and a second plate member, the first plate member and the second plate member coupled to two opposing edges of the base member to form a chamber configured to receive a vertically disposed can object subject to a compacting operation;
a compactor member configured to supply a compacting surface and receive a force to guidingly move the compacting surface, compactor member including a compactor plate providing the compacting surface, a linkage connector configured to link the compactor plate to a lever-to-compactor linkage member, and a guide moving part configured to guide the compactor plate to move along a compactor-guiding member by moving on and along the compactor-guiding member;
the compactor-guiding member configured to allow the guide moving part of the compactor member to move thereon and move there-along;
a lever member including a lever extending from proximal end to a distal end, and a linkage connector configured to link the lever to the lever-to-compactor linkage member;
a lever-anchoring member configured to pivotally anchor the lever at the proximal end of the lever;
the lever-to-compactor linkage member configured to link the lever of the lever member and the compacting surface of the compactor member such that a pivotal displacement of the distal end of the lever in a downward direction causes the compacting surface to guidingly urge downward against the vertically disposed can, and the downward urging of the compacting surface generates a big enough counter-force against the can object to cause the can object to be fully compacted; and
a mounting member configured to mount the apparatus against a physical standing structure.

2. The apparatus of claim 1, wherein the compactor-guiding member comprises two parallel guide rods extending from the first plate member to the second plate member.

3. The apparatus of claim 2, wherein the guide moving part of the compactor member comprises two guiding movers each configured to move on and along one of the two guide rods.

4. The apparatus of claim 3, wherein each of the two guiding movers comprise a sleeve part configured to slidably move on and along one of the two guide rods.

5. The apparatus of claim 1, wherein the lever-to-compactor linkage member comprises two linkage bars, each linkage bar having a first end coupled to the linkage connector of the compactor member and a second end coupled to the lever.

6. The apparatus of claim 1, wherein the lever-anchoring member pivotally anchor the proximal end of the lever by pivotally fastening the proximal end of the lever to lever-anchoring member through a fastening pin such that the distal end of the lever may pivot about the fastening pin.

7. The apparatus of claim 1, wherein the first plate member comprises a channel configured to let the lever-to-compactor linkage member extend there-through during an active can-compacting operation and let the lever extend there-through when the distal end of the lever is displaced to a maximum stop position.

8. The apparatus of claim 1, wherein the compactor plate of the compactor member has at least one opening for relieving air pressure during an active can-compacting operation.

9. The apparatus of claim 1, wherein the second plate member at least one opening for relieving air pressure during an active can-compacting operation.
